(19) United States
(12) Patent Application Publication
(10) Pub. No.: US 2017/0132190 A1
(43) Pub. Date: May 11, 2017

(54) RECOMMEND CONTENT SEGMENTS BASED ON ANNOTATIONS

(71) Applicant: Hewlett-Packard Development Company, L.P., Fort Collins, CO (US)

(72) Inventors: Georgia Koutrika, Palo Alto, CA (US); Lei Liu, Palo Alto, CA (US); Jerry Liu, Palo Alto, CA (US); Steven J Simske, Ft. Collins, CO (US)

(21) Appl. No.: 15/321,105

(22) PCT Filed: Jun. 30, 2014
(86) PCT No.: PCT/US2014/044839

§ 371 Date: Dec. 21, 2016

(51) Int. Cl. G06F 17/24; G06F 17/30

(52) U.S. Cl. CPC G06F 17/241; G06F 17/243; G06F 17/30675; G06F 17/30719

(57) ABSTRACT

Examples disclosed herein relate to recommending content segments based on annotations. In one implementation, a processor determines content segments based on user data related to annotations of the content. The processor recommends at least one of the content segments based on the relative value of the content segment to the other content segments. For example, the value of a content segment may be determined based on the annotations associated with the content segment.

### BACKGROUND

Readers may provide annotations to digital text, such as by including highlights, comments, links, footnotes, tags, and underlines. For example, an e-reader may allow a user to insert information or associate information with the text. The annotations may be used to emphasize portions of the text or to add information to the text, such as through comments and links.

### BRIEF DESCRIPTION OF THE DRAWINGS

The drawings describe example embodiments. The following detailed description references the drawings, wherein:

FIG. 1 is a block diagram illustrating one example of a computing system to recommend content segments based on annotations.

FIGS. 2A and 2B are diagrams illustrating one example of recommending content based on annotations.

FIG. 3 is a flow chart illustrating one example of a method to recommend content segments based on annotations.

FIG. 4 is a flow chart illustrating one example of a method to divide content into segments based on annotations.

FIG. 5 is a flow chart illustrating one example of a method to divide and merge content into segments based on annotations.

### DETAILED DESCRIPTION

Using annotations to determine helpful content for others facilitates social aspects to learning. However, as electronic annotations become easier to create, the multitude of annotations and the complexity of parsing overlapping, potentially conflicting, annotations may make the annotations difficult to use due to the overload of information. In one implementation, a processor analyzes the many annotations to determine how to recommend content in a manner that takes into account the way that the group of previous users interacted with the content and added to it. For example, a processor may determine content segments based on user data related to annotations of the content, and the processor may recommend a content segment based on the relative value of the content segment to the other content segments where the value of a content segment is determined based on the annotations associated with the content segment. The processor may output the content segment for recommendation and/or emphasize the recommended portion within a larger content segment, such as where a page is displayed with a highlighted portion to emphasize the selected content segment. In one implementation, information about the content of the annotations in the recommended segment may be displayed.

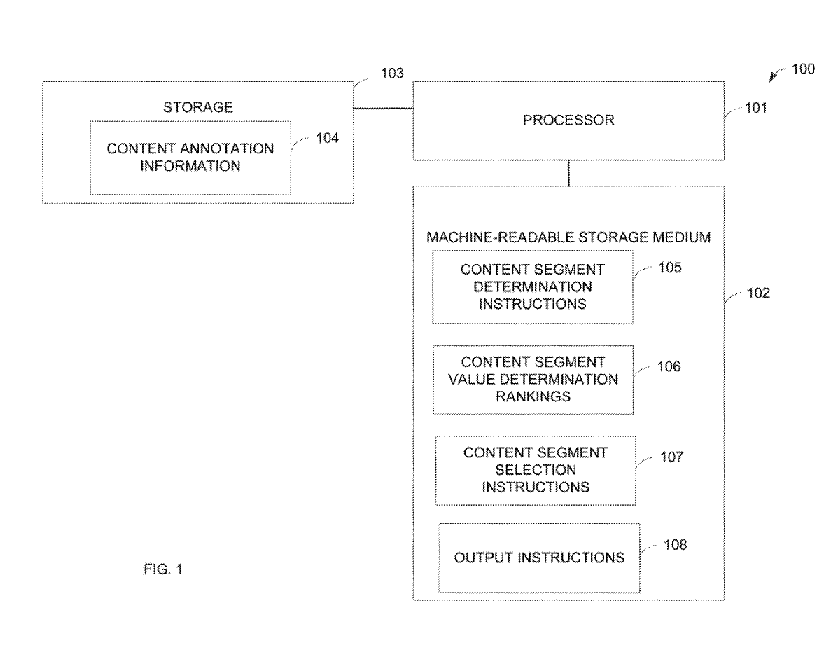

FIG. 1 is a block diagram illustrating one example of a computing system 100 to recommend content segments based on annotations. For example, the computing system 100 may determine content to recommend to a user based on annotations associated with the content.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The storage 103 may be any suitable storage in communication with the processor 101. For example, the processor 101 may receive information from the storage 103 directly or via a network. For example, the storage 103 may be a server to store content annotation information 104. The content annotation information 104 may be received from multiple user electronic devices where users annotate the content. The processor 101 or another processor may receive the information from user devices, format the information, and store it in the storage 103.

The content may be, for example, text, image, video, or audio. The annotations may be any suitable note to the content, such as an emphasis added (ex. highlight or underline), comment, footnote, tag, or link. The annotations may be any suitable length, such as a marking to a chapter page, word, sentence, paragraph, or image.

The content annotation information 104 may include information about the section of the content that is annotated, such as annotation start and end position or annotation start position and length, as well as information about the annotation itself. For example, paragraph 1 may be annotated, and the annotation may be a highlight or a comment added. In some implementations, the content annotation information 104 includes information about the user that created the annotation, such as the age, location, grade level, or interests of the user. In some implementations, the content annotation information 104 includes information about other users that used the annotation, such as based on explicit feedback, a user clicking a link, or a user skipping to a highlight. The content annotation information 104 may include information about the creation date of the annotation. The stored information may vary based on the type of annotation, such as whether it is an emphasis or a link. In some implementations, the annotation information is stored as tags in the document and the documents themselves are stored.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include content segment determination instructions 105, content segment value determination instructions 106, content segment selection instructions 107, and output instructions 108.

The content segment determination instructions 105 include instructions to divide content into segments based on the content annotation information 104, such as aggregated information about annotations associated with the content. For example, the way in which the content was annotated may be used to determine how to segment the content into discrete parts.

The content segment value determination instructions 106 include instructions to determine a value for each of the content segments. For example, the value may be based on the number of annotations in the segment, the creators of the annotations in the segment, the type of annotations in the segment, the content of the annotations in the segment, the length of the annotations in the segment, the amount of the segment associated with annotations, and/or priority information associated with the annotations in the segment.

The content segment selection instructions 107 include instructions to rank the contents based on the relative value of the segments. The content segments may be selected where the value is above a threshold and/or the content segments with the top N values.

The output instructions 108 include instructions to recommend'content based on the rankings. For example, emphasis may be added to the segment, the particular segment may be displayed to a user, or the particular segment may be transmitted to the user.

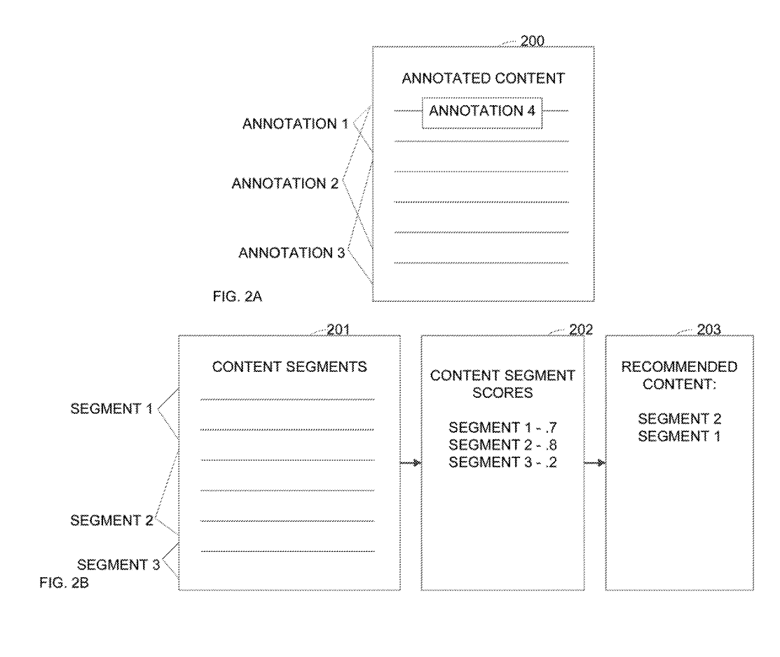

FIGS. 2A and 2B are diagrams illustrating one example of recommending content based on annotations. FIG. 2A is a diagram illustrating one example of annotated content. Annotated content 200 shows content with 4 annotations. In some cases, annotations may overlap or be subsumed by one another. For example, annotations 2 and 3 are overlapping, and annotation 4 is subsumed by annotation 1 and 2. FIG. 2B is a flow chart illustrating one example of recommending content segments based on the annotated content 200 in FIG. 2A. Block 201 shows the content 200 divided into 3 segments based on the position of the annotations. Block 202 shows content segment scores associated with each of the 3 segments. For example, the content segment scores of segment 1 and 2 are higher than that of segment 3. Block 203 shows content segments 1 and 2 selected for recommendation.

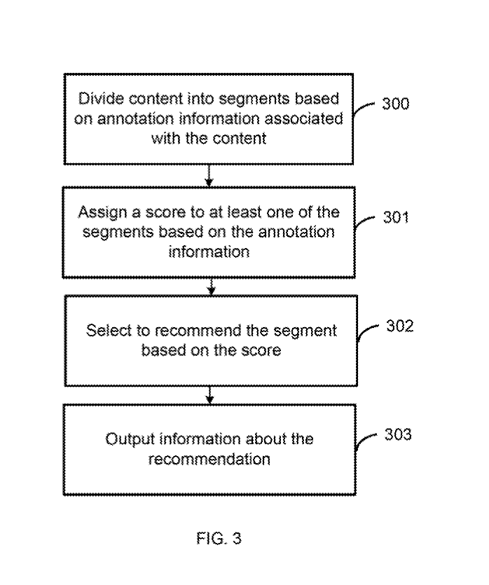

FIG. 3 is a flow chart illustrating one example of a method to recommend content segments based on annotations. For example, a group of users may create many overlapping unstructured annotations. The annotations may be, for example, an emphasis added (ex. highlight or underline), comment, link, footnote, or tag. A processor may determine how to parse the content into sections and which sections to recommend, based on the annotations from previous users of the content. The method may be implemented, for example, by the computing system 100.

Beginning at 300, a processor divides content into segments based on annotation information associated with the content. In one implementation, the processor may filter the annotation information for particular types of annotations prior to analyzing the annotation information. For example, the processor may filter based on information in addition to the annotation itself, such as the time, date, creator of the annotation, and/or authority associated with the annotation. In one implementation, a user creating an annotation may associate a permissions field with the annotation, such as whether to share publically, keep private, or share with a particular group. The permissions information may be used to determine if the highlight may be used for the recommendation process.

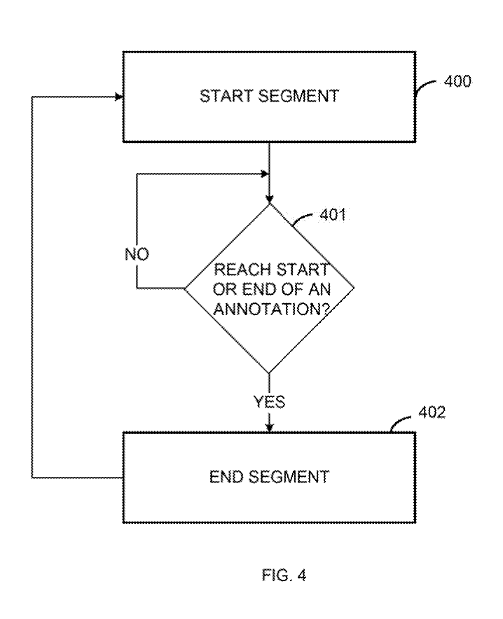

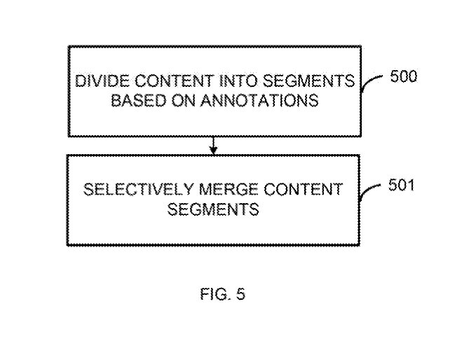

The processor may divide the content into any suitable segments based on the annotation information, such as based on the position or content of the annotations. For example, the methods described in FIGS. 4 and 5 may be used. The segments may be consecutive non-overlapping segments such that each portion of the content is associated with a single segment. The processor may divide the content into segments in any suitable manner. In one implementation, multiple factors are considered and weighted, such as the position of annotations, the type of annotations, and the creator of the annotations. In some implementations, information in addition to the annotations may be considered. For example, the position of the annotations may be weighted and the topic of the segment may also be weighted, such as where the topic is determined based on an automatic text analysis method. Other factors, such as changes to the content may be considered.

In one implementation, the processor divides the content into segments and then merges some of the segments, such as to create a target number of segments. In one implementation, the segments are merged based on a target length of the segments. The segments may be merged based on the type, length, creator, or content of the annotations. For example, segments with similar types of annotations or similar comments may be merged into a single segment. The processor may divide the content into segments periodically as new annotations are added by additional users. For example, the processor may perform the process again or update some segments.

Continuing to 301, a processor assigns a score to at least one of the segments based on the annotation information. For example, the value of a segment may be based on the number of annotations in the segment, the creators of the annotations in the segment, the type of annotations in the segment, the content of the annotations in the segment, the length of the annotations in the segment, the amount of the segment associated with annotations, and/or priority information associated with the annotations in the segment. For example, the score may be higher for a longer annotation or for a higher priority annotator. In one implementation, an annotation is scored based on a sentiment associated with the annotation, such as whether it is considered a positive or negative annotation. If annotations within a segment are determined to be negative, the presence of many annotations in a segment may lower rather than raise the score of the segment. In one implementation, annotations determined to be negative are not taken into account when determining the value of a segment. For example, the processor may filter out the negative annotation information before scoring a segment. In some implementations, the segments may be filtered prior to assigning the score. Value information in addition to the annotation information may also be used.

The processor may determine the value of the segments based on characteristics of the particular user to whom the content is to be recommended. For example, the age, grade level, achievement information, or other information about the user to whom the, content is recommended. In some implementations, a similarity between the user and the annotation creator and/or other users that found the annotation helpful may be taken into account.

In one implementation, the processor determines a score for segment s as the following:

$${score}_{s} = \frac{{\sum }_{( u , t , a ) s ⋂ t \neq φ} \frac{\vert {I}_{t} - {I}_{s} \vert}{{I}_{s}} {w}_{u}}{{\sum }_{( u , t , a )} {w}_{u}} ,$$

where score is computed over all annotations (u,t,a) made by a user u, over a text t that intersects with segment s. The score is the weighted sum of the length of the fraction of s covered by t multiplied by the priority weight wu of the annotator u normalized by the number of annotations with priorities where w is the priority weight.

Continuing to 302, a processor selects to recommend the segment based on the score. For example, the processor may select content with scores above a threshold or the content with the top N scores. In some implementations, further information about the content is analyzed, such as by further filtering the segments based on whether they include images or audio. The processor may automatically determine an amount of content to recommend, such as based on the view or zoom level of the user device associated with the request. For example, the same number of segments may be selected whether a user is viewing one or two pages such that the selection criteria is altered. In one implementation, the segment selected may be based on the user device associated with the user, such as where a segment including video content may not be selected for a particular user or user device.

Continuing to 303, a processor outputs information about the recommendation. The processor may recommend the content in any suitable manner. For example, the processor may display or transmit the content. The processor may transmit, display, or otherwise recommend the segment or transmit, display, or otherwise make the content available with an emphasis added to the recommended portion. For example, selected segments 2 and 3 may correspond to segments of a chapter that are then transmitted to a user.

In one implementation, the processor stores information about the recommendation to be delivered to the user by another device. In one implementation, the processor creates an aggregated version of content based on multiple segments of recommended content, such as where multiple chapters are selected and put together into a custom book. The processor may prioritize the recommendations such that they may be displayed differently. For example, segments may be highlighted in different colors or intensities based on the prioritization. The recommendation may be the segments or the segments with, the annotations. For example, a segment may be recommended and the accompanying comments and or specific highlights or a subset of the comments and highlights may also be shown. In one implementation, the information about the type and content of the annotations is analyzed and prioritized such that a user may view, for example, the top three ranked comments associated with a recommended segment. In one implementation, a user interface is presented such that a user views the selected segment and may click to view the associated comments.

In one implementation, the recommendation is hierarchical. For example, a particular chapter may be selected, paragraphs within the chapter may be selected, and sentences within the paragraphs may be selected. In one implementation, information about the recommendations are displayed. For example, a user may view the top 5 segments and their associated annotations such that the user may select a segment to view in more detail. In one implementation, the user can view the hierarchy and a set recommendations for each level such that the user may select between recommendations at each level.

In one implementation, multiple segments are recommended as a group. For example, the processor may determine an aggregate score for a set of segments. The aggregate score may be determined based on the individual segment scores and additional information related to the relationship between the segments. For example, segments 1, 3, and 5 may be compared to segments 2, 4, and 6.

FIG. 4 is a flow chart illustrating one example of a method to divide content into segments based on annotations. For example, a processor may divide the content into consecutive non-overlapping segments based on information about previous annotations to the content. The content may be divided into segments by a processor analyzing a list of tags and their positions associated with annotations and/or scanning the content to find the next annotation tag. For example, an annotation tag may indicate the beginning or end of an annotation. The tags may be nested, such as where the annotations are overlapping. The ending point of a first segment and starting point of a second segment may be identified where either a new annotation begins or a previously identified annotation ends.

Beginning at 400, a processor starts a segment. For example, the segment may be started at the beginning of the content. Continuing to 401, the processor checks to see if the start or end of an annotation is reached, such as by scanning the next tag in an ordered list or by scanning the next position in the content. If a start or end of an annotation is reached, the process proceeds to 402 and ends the current segment and starts a new segment. If the start or end of an annotation is not reached, the processor returns to 401 to check the next position. The processor may then output information about the beginning and ending points of the identified segments.

FIG. 5 is a flow chart illustrating one example of a method to divide and merge content into segments based on annotations. Beginning at 500, a processor divides content into segments based on annotations. For example, the method shown in FIG. 4 may be used to create the segments. In some implementations, the processor filters the annotations, such as by date or user, and analyzes the remaining annotations.

Continuing to 501, a processor selectively merges the content segments. For example, the number of segments may be more numerous than desired. Segments may be selected for merging based on overlap of annotations, proximity of annotations, number of segments, number of segments per amount of content, and/or target segment length. Merging the segments may result in more cohesive recommendations to users. For example, it may be desirable to recommend segments that fully explore a concept in some cases as opposed to a single word segment.

In one implemenation, a processor follows a greedy approach. For example, the processor scans the segments and merges a first segment with the next segment if the length of the first segment is smaller than a target maximum length and the combined segment would be smaller than a target maximum length. The merged segment may then be compared to the next segment. The process may be repeated for each of the segments.

In one implementation, the processor performs multiple iterations. For example, in the first iteration, the processor determines sets of two initial segments that satisfy a length criteria, and any merged segments that do not satisfy the criteria are pruned. In the second iteration, the process is repeated with the input segments being the merged segments from the first iteration. The iterations may be repeated, and in a final iteration, the processor may select a set of merged segments that includes the minimum number of segments that cover the desired portions, such as the annotated portions.

The merged segments may then be ranked, and the processor recommends segments to the user based on the rankings. Using annotations to both divide and recommend content allows for voluminous conflicting annotations to be consolidated in a manner that is comprehensible to a user.

1. A computing system, comprising:
a storage to store annotation information associated with content; and
a processor to:
determine segments of the content based on an aggregation of the annotation information;
determine values associated with the content segments based on the annotation information associated with each of the segments;
select at least one of the content segments for a user based on the values; and
output information about the selection.

2. The computing system of claim 1, wherein the processor determines the values based on characteristics of the particular user.

3. The computing system of claim 1, wherein an annotation comprises at least one of: an emphasis, link, footnote, tag, and underline.

4. The computing system of claim 1, wherein the value of a segment is based on at least one of: the number of annotations in the segment, a creator of an annotation in the segment, a type of annotation in the segment, the content of an annotation in the segment, the length of an annotation in the segment, the amount of the segment associated with annotations, sentiment information associated with the annotation, and priority information associated with an annotation in the segment.

5. The computing system of claim 1, wherein the processor selects multiple segments based on an aggregated value of the segments.

6. The computing system of claim 1, wherein the processor further selects a subset of the annotation information associated with the content based on sharing permissions information associated with the subset of annotations.

7. A method comprising:
dividing, by a processor, content into segments based on annotation information associated with the content;
assigning a score to at least one of the segments based on the annotation information;
selecting to recommend the segment based on the score; and
outputting information about the recommendation.

8. The method of claim 7, wherein dividing content into segments comprises:
dividing content into segments based on the position of annotations within the content; and
selecting segments to merge into a single segment;

9. The method of claim 8, wherein selecting segments to merge comprises selecting segments based on at least one of: overlap of annotations, proximity of annotations, number of segments, number of segments per amount of content, and segment length.

10. The method of claim 8, wherein dividing content into segments comprises determining an ending point of a first segment and a starting point of a second segment where at least one of: a new annotation begins and a previously identified annotation ends.

11. The method of claim 7, wherein selecting the segment comprises selecting the segment to recommend based on the amount of content selected to view in a user device associated with the user.

12. The method of claim 7, further comprising selecting a second segment based on an aggregate score associated with the segment and the second segment.

13. A machine-readable non-transitory storage medium comprising instructions executable by a processor to:
determine content segments based on user data related to annotations of the content; and
recommend at least one of the content segments based on the relative value of the content segment to the other content segments, wherein the value of a content segment is determined based on the annotations associated with the content segment.

14. The machine-readable non-transitory storage medium of claim 13, wherein instructions to determine content segments comprise instructions to determine consecutive non-overlapping segments of the content based on unstructured annotations.

15. The machine-readable non-transitory storage medium of claim 13, wherein the value of a content segment is determined based on at least one of: the number of annotations in the segment, a creator of an annotations in the segment, a type of annotation in the segment, the content of the an annotation in the segment, the length of an annotation in the segment, the amount of the segment associated with annotations, and priority information associated with an annotation in the segment.
